(19) United States
(12) Patent Application Publication
(10) Pub. No.: US 2025/0310925 A1
(43) Pub. Date: Oct. 2, 2025

(54) METHOD FOR PERFORMING A SIDELINK POSITIONING OR RANGING PROCEDURE IN A COMMUNICATION SYSTEM AND A NETWORK SYSTEM

(71) Applicant: Beijing Xiaomi Mobile Software Co., Ltd., Beijing (CN)

(72) Inventor: Wei LU, Beijing (CN)

(73) Assignee: Beijing Xiaomi Mobile Software Co., Ltd., Beijing (CN)

(21) Appl. No.: 18/865,556

(22) PCT Filed: May 16, 2022
(86) PCT No.: PCT/CN2022/093158

§ 371 Date: Nov. 13, 2024

(51) Int. Cl. H04W 64/00; H04W 12/02; H04W 12/63; H04W 60/04; H04W 92/18

(52) U.S. Cl. CPC H04W 64/00; H04W 12/02; H04W 12/63; H04W 60/04; H04W 92/18

(57) ABSTRACT

A method for performing at least one of ranging or SL positioning in a communication system, where the communication system includes a network system, an application server (AS), a first User Equipment (UE1) and a second User Equipment (UE2), and where the network system includes a network exposure function (NEF), a unified data management function (UDM) and an access and mobility management function (AMF), the method including: registering the UE1 and UE2 with the network system; receiving a sidelink positioning request or a ranging service request from the AS; sending a data retrieval request to the UDM, evaluating the privacy profile data of the UE1 and UE2; performing at least one of ranging or SL positioning; and sending at least one of a ranging or SL positioning result to the AS.

### CROSS-REFERENCE TO RELATED APPLICATIONS

The present application is a U.S. National Stage of International Application No. PCT/CN2022/093158, filed on PCT May 16, 2022, the contents of all of which are incorporated herein by reference in their entireties for all purposes.

### BACKGROUND

Ranging and SL positioning belong to the key functions in a communication system such as 5G communication systems. In some applications, the mentioned techniques allow an efficient communication between two vehicles (also referred to as V2V or vehicle-to-vehicle communication) or between a vehicle and another component being located in the vicinity of the vehicle, such as a traffic lamp or a monitoring device of a construction area (also referred to as V2X or vehicle-to-everything communication). Therefore, ranging/SL positioning belongs to crucial techniques when it comes to critical applications such as autonomous driving

In general, the ranging/SL positioning can be initiated by a network function (NF) of a network system or, alternatively, by an external application server (AS). In applications, the application server can also be referred to as a ranging server (RS) or an application function (AF). According to the present disclosure, the ranging/SL positioning is initiated by an AS.

Due to the significance of ranging/SL positioning, different techniques for providing high-precision positioning measurements are suggested in different communication standards such as in the 5G communication standard.

### SUMMARY

According to first aspect of the present disclosure, a method is proposed for performing at least one of a sidelink positioning procedure or a ranging procedure in a communication system, in particular in a 5G communication system, the communication system includes a network system, an application server (AS), a first User Equipment (UE1) and a second User Equipment (UE2), and where the network system includes a network exposure function (NEF), a unified data management function (UDM) and an access and mobility management function (AMF), the method comprising:
registering, by UE1 and UE2, with the network system;
receiving, by the NEF, a sidelink positioning request or a ranging service request from the AS;
sending, by the NEF, a data retrieval request to the UDM, the data retrieval request prompts the UDM to provide privacy profile data of the UE1 and the UE2, and the privacy profile data indicates whether a first user consent to share location information associated with the UE1 is present and whether a second user consent to share location information associated with the UE2 is present;
   receiving, by the NEF, the privacy profile data from the UDM;
   evaluating, by the NEF, the privacy profile data of the UE1 and UE2; and
   in case that the preceding evaluation has resulted in the presence of the first user consent to share location information associated with the UE1 and in the presence of the second user consent to share location information associated with the UE2:
performing at least one of the sidelink positioning procedure or the ranging procedure;
sending, by the NEF, at least one of a sidelink positioning result or a ranging service result to the AS.

According to a second aspect of the present disclosure, a method is proposed providing, by a unified data management (UDM), assistance information to a network exposure function (NEF), for performing at least one of a sidelink positioning procedure or a ranging procedure in a communication system, in particular in a 5G communication system, the communication system includes a network system, an application server (AS) a first User Equipment (UE1) and a second User Equipment (UE2), and the network system includes the network exposure function (NEF), the unified data management function (UDM) and an access and mobility management function (AMF), the method comprising:
receiving, by the UDM, a data retrieval request from the NEF, the data retrieval request prompts the UDM to provide privacy profile data of the UE1 and the UE2, and the privacy profile data indicates whether a first user consent to share location information associated with the UE1 is present, and whether a second user consent to share location information associated with the UE2 is present;
retrieving, by the UDM, the privacy profile data of the UE1 and the UE2 from a database within the UDM, in particular from a unified data repository (UDR) of the UDM; and
sending, by the UDM, the retrieved privacy profile data of the UE1 and the UE2 to the NEF.

According to a third aspect of the present disclosure, a method is proposed for providing, by an Access and Mobility Management Function (AMF), position estimation data for a first User Equipment (UE1) and a second User Equipment (UE2) for performing at least one of a sidelink positioning procedure or a ranging procedure in a communication system, in particular in a 5G communication system, the communication system includes a network system, an application Server (AS), the first User Equipment (UE1) and the second User Equipment (UE2), and the network system includes a network exposure function (NEF), a unified data management function (UDM) and the access and mobility management function (AMF), the method comprising:
receiving, by the AMF, a request message for obtaining the position estimation data for at least one of the UE1 or the UE2 being associated with an area-specific consent data from the NEF or from the UDM;
sending, by the AMF, the requested position estimation data for at least one of the UE1 or the UE2 associated with the area-specific consent data to the requesting NEF or the requesting UDM.

According to a fourth aspect of the present disclosure, a network system is proposed that can be implemented in a communication system, in particular to be implemented in a 5G communication system, the network system includes a network exposure function (NEF), a unified data management function (UDM) and an access and mobility management function (AMF), the NEF is configured to:
receive a sidelink positioning request or a ranging service request from an application server (AS);
send a data retrieval request to the UDM, the data retrieval request prompts the UDM to provide privacy profile data of a first User Equipment (UE1) and a second user equipment (UE2), and the privacy profile data indicates whether a first user consent to share location information associated with the UE1 is present and whether a second user consent to share location information associated with the UE2 is present;
receive the privacy profile data from the UDM;
evaluate the privacy profile data of the UE1 and UE2;
in case that the preceding evaluation has resulted in the presence of the first user consent to share location information associated with the UE1 and in the presence of the second user consent to share location information associated with the UE2:
initiate at least one of a sidelink positioning procedure or a ranging procedure;
send at least one of a sidelink positioning result or a ranging service result to the AS.

According to a fifth aspect of the present disclosure, a network system is proposed that can be implemented in a 5G communication system, the network system includes a network exposure function (NEF), a unified data management function (UDM) and an access and mobility management function (AMF), the UDM is configured to:
receive a data retrieval request from the NEF, the data retrieval request prompts the UDM to provide privacy profile data of the UE1 and the UE2, and the privacy profile data indicates whether a first user consent to share location information associated with the UE1 is present, and whether a second user consent to share location information associated with the UE2 is present;
retrieve the privacy profile data of the UE1 and the UE2 from a database within the UDM, in particular from a unified data repository (UDR) of the UDM; and
sending the retrieved privacy profile data of the UE1 and the UE2 to the NEF.

According to a sixth aspect of the present disclosure, a network system is proposed that can be implemented in a communication system, in particular to be implemented in a 5G communication system, the network system includes a network exposure function (NEF), a unified data management function (UDM) and an access and mobility management function (AMF), the AMF is configured to:
receive a request message for obtaining the position estimation data for at least one of the UE1 or the UE2 being associated with an area-specific consent data from the NEF or from the UDM;
send the requested position estimation data for at least one of the UE1 or the UE2 associated with the area-specific consent data to the requesting NEF or the requesting UDM.

According to a seventh aspect of the present disclosure, a user equipment (UE) is proposed that can be used in a communication system, in particular in a 5G communication system, the UE includes a processing unit, a communication unit and a storage unit, the storage unit has privacy profile data stored thereon, the privacy profile data indicates whether a user consent to share location information associated with the UE1 is present.

According to an eighth aspect of the present disclosure, a computer program product is proposed that, when executed by a processing unit, causes the processing unit to perform the method according to any one of the above-described methods.

### BRIEF DESCRIPTION OF DRAWINGS

In order to more clearly describe technical solutions in examples of the disclosure or the background art, the accompanying drawings required for the examples of the disclosure or the background art will be illustrated below.

FIG. 1 is a schematic representation of a communication system according to an embodiment of the present disclosure;

FIG. 2 is a schematic representation of a ranging/sidelink positioning procedure according to an embodiment of the present disclosure;

FIG. 3 is a flow chart of one embodiment of the method according to an embodiment of the present disclosure;

FIG. 4 is a flow chart illustrating more detailed method steps for evaluating the privacy profile data of the UE1 and the UE2 according to an embodiment of the present disclosure;

FIG. 5 is a flow chart illustrating more detailed method steps for obtaining position estimation data for the UE1 and/or the UE2 being associated with area-specific consent data according to an embodiment of the present disclosure;

FIG. 6 is a schematic representation of a further embodiment of the method according to an embodiment of the present disclosure, the NEF is configured to communicate with the AMF via the UDM;

FIG. 7 is a schematic representation of a further embodiment of the method according to an embodiment of the present disclosure, the NEF is configured to communicate directly with the AMF; and

FIG. 8 is a schematic representation of a User Equipment according to an embodiment of the present disclosure.

### DETAILED DESCRIPTION OF THE DRAWINGS

However, due to reasons of privacy protection, a user who is registered with his User Equipment in a communication system and who uses various communication services (such as voice services or message services) of a telecommunication provider may not consent to sharing his current location (i.e. the current location of the User Equipment used by him) with the provider. Nevertheless, the techniques suggested according to the related art do not provide any efficient means for handling user consent for sharing location information.

In view of the above, in order to solve the above-mentioned problem, it is the objective of the present disclosure to provide a method for performing a ranging/SL positioning procedure in a communication system (in particular in a 5G communication system) enabling an efficient handling of user privacy preferences, the ranging/SL positioning procedure is initiated by an AS.

The present disclosure relates to a method for performing a sidelink positioning procedure and/or a ranging procedure (also referred to as SL positioning/ranging or ranging/SL positioning) in a communication system, in particular in a 5G communication system. The present disclosure also relates to a method for providing assistance information to a network function for performing ranging/SL positioning in a communication system and a method for providing position estimation data corresponding to a first User Equipment (also referred to as UE1) and a second User Equipment (also referred to as UE2). Furthermore, the present disclosure relates to a network system that is configured to be implemented in a communication system, in particular to be implemented in a 5G communication system. Finally, the present disclosure relates to a User Equipment (UE) to be implemented in a communication system and a computer program product.

In FIG. 1, a schematic representation of a communication system according to the present disclosure is illustrated. The communication system shown in FIG. 1 corresponds to a typical 5G communication system as known from the related art. The communication system includes a network system 20, an application server (AS) 21 a User Equipment (UE) 22, an access network 23 (referred to as the NG-RAN or Next Generation Radio Access Network), a user plane function (UPF) 24 and a data network (DN) 25. The network system 20 includes several functions such as the access and mobility management function (AMF) 35, the session management function (SMF) 26, the network exposure function (NEF) 27, the unified data management (UDM) 28 the policy control function (PCF) 29, the direct discovery name management service (DDNMF) 30 and an additional network function (NF) 31. The UE connects to the network system 20 via interface N1. More specifically, the UE connects to the AMF of the network system 20 via interface N1. Furthermore, the AMF 35 connects to the NG-RAN via interface N2. The different functions of the network system 20 can interact with each other and exchange data. For instance, the UDM may provide subscription data of the user equipment to other network functions. Data retrieval from the UDM may be initiated by sending a corresponding request to the UDM. The network system 20 is connected with the UPF, which is connected with the DN. The AS may be implemented as an application function or as a ranging server. The AS can be configured to send requests to the NEF of the network system 20. In particular, the AS can be configured to send a ranging/SL positioning request to the NEF. The communication system as illustrated in FIG. 1 is in principle known as a 5G communication system according to the related art. However, the present disclosure may also be implemented in other communication systems that do not completely fulfill all requirements of the 5G communication standard, but only implement some of the core elements that are involved in the method according to the present disclosure.

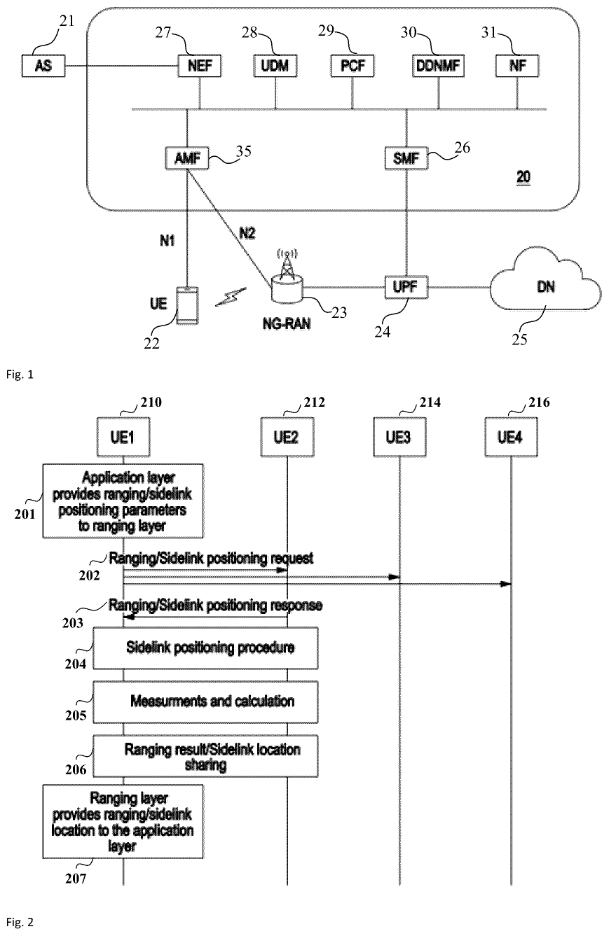

In FIG. 2, a schematic representation of a ranging/SL positioning procedure as known from the related art is illustrated. In step 201, the application layer provides the ranging/SL positioning parameters to the ranging layer. In step 202, the first user equipment UE1 210 may send a ranging/SL positioning request to a second equipment UE2 212, to a third user equipment UE3 214, and/or to a fourth user equipment UE4 216. The ranging/SL positioning request may be broadcasted from the UE1 to the other UEs. The corresponding message may include UE1's application layer ID, the target UE's application ID and required quality of service (QOS). In response to receiving the ranging/SL positioning request, UE2 may return a ranging/SL positioning response to UE1, if the application layer ID for UE2 matches (see step 203). Subsequently, in steps 204 to 206, UE1 may initiate the SL positioning procedure, UE1 or UE2 may obtain the positioning measurements and calculate the ranging/SL positioning result, and UE1 and UE2 may share the ranging/SL positioning result. Finally, in step 207, the ranging layer of UE1 may provide the ranging/SL positioning result to the application layer.

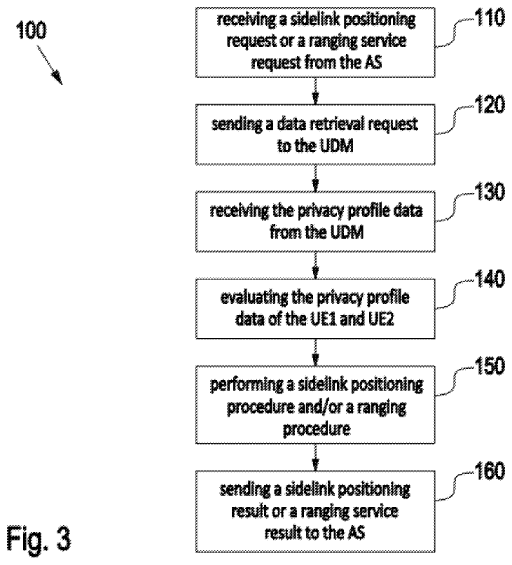

In FIG. 3, an embodiment of method 100 according to the present disclosure is illustrated. In a first step 110, the NEF may receive a ranging/SL positioning request from the AS. In a second step 120, the NEF sends a data retrieval request to the UDM. The data retrieval request prompts the UDM to provide privacy profile data of both the UE1 and the UE2. The privacy profile data indicates whether the consent of a first user is granted to share location information associated with the UE1, and whether the consent of a second user is granted to share location information associated with the UE2. In a third step 130, the NEF receives the privacy profile data from the UDM. In a fourth step 140, the NEF evaluates the received privacy profile data associated with the UE1 and UE2. In a fifth step 150, the SL positioning/ranging procedure is performed, in case the preceding evaluation in step 140 has resulted in the presence of the first user consent to share location information associated with the UE1 and in the presence of the second user consent to share location information associated with the UE2. In other words, the SL positioning/ranging procedure is initiated in case the first user and the second user have granted their consent that the location information of their UE may be shared with the network system 20. Finally, in a sixth step 160, the NEF sends a ranging/SL position result to the AS.

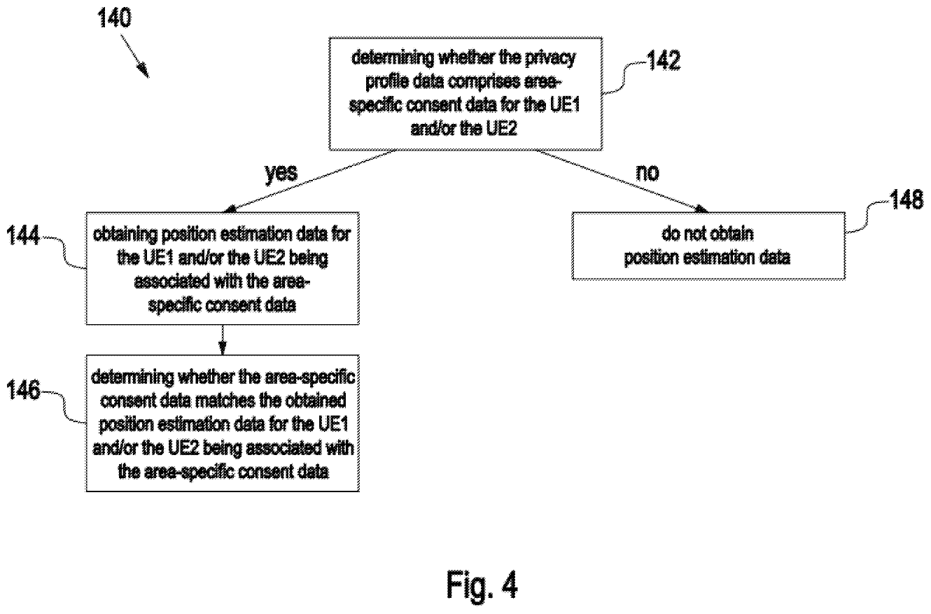

In FIG. 4, the method steps for evaluating 140 the privacy profile data of the UE1 and the UE2 according to an embodiment of the present disclosure are illustrated in more detail. According to a first substep 142, it is determined whether the privacy profile data received by the UDM includes area-specific consent data for the UE1 and/or the UE2. This determination step is conducted by the NEF, which can be the AMF or any other network function of the network system. In case it is determined that the privacy profile data includes area-specific consent data for at least one of the UE1 and UE2, in a second substep 144, position estimation data for the UE1 and/or the UE2 associated with the area-specific consent data is obtained by the NEF. If the privacy profile data includes area-specific consent data for both of the UEs, position estimation data is obtained for each of the UEs accordingly. For obtaining position estimation data, any of the procedures known from the related art can be implemented. For instance, the NEF may estimate the position of UE1/UE2 by evaluating the cell-ID of UE1/UE2. Further, the tracking area identity (TAI) may be used to determine the (rough) position of one of the UEs. In a third substep 146, the NEF determines whether the area-specific consent data matches the obtained position estimation data for the UE1 and/or the UE2 being associated with the area-specific consent data. For instance, if the area-specific consent data indicates that the consent of the first user to share his location information is granted for a specific city and the position estimation data indicates that the first user (i.e. his User Equipment UE1) is located in the same city, the obtained position estimation data matches with the area-specific consent data. In this case, it is determined that the user consent for sharing location information is granted for the current position of the first user. However, if the user consent for sharing location information is not granted for the current position of the first user, the ranging/SL positioning procedure may be aborted and a corresponding notification may be generated. If the first substep 142 has yielded that no area-specific consent data is included in the privacy profile data for both UE1 and UE2, no position estimation data is obtained (see substep 148).

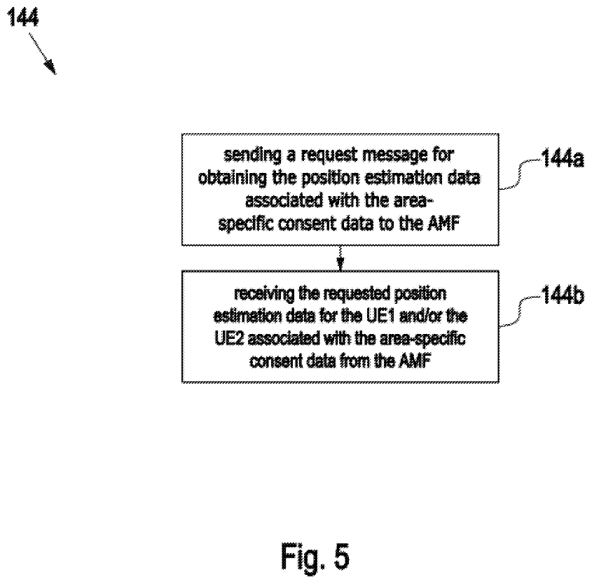

In FIG. 5, the method steps for obtaining 144 position estimation data for the UE1 and/or the UE2 being associated with the area-specific consent data according to an embodiment of the present disclosure are illustrated in more detail. According to the embodiment illustrated in FIG. 5, a request message for obtaining the position estimation data associated with the area-specific consent data is sent from the NEF to the AMF in a first substep 144a. Subsequently, in a second substep 144b, the NEF receives the requested position estimation data for the UE1 and/or the UE2 associated with the area-specific consent data from the AMF.

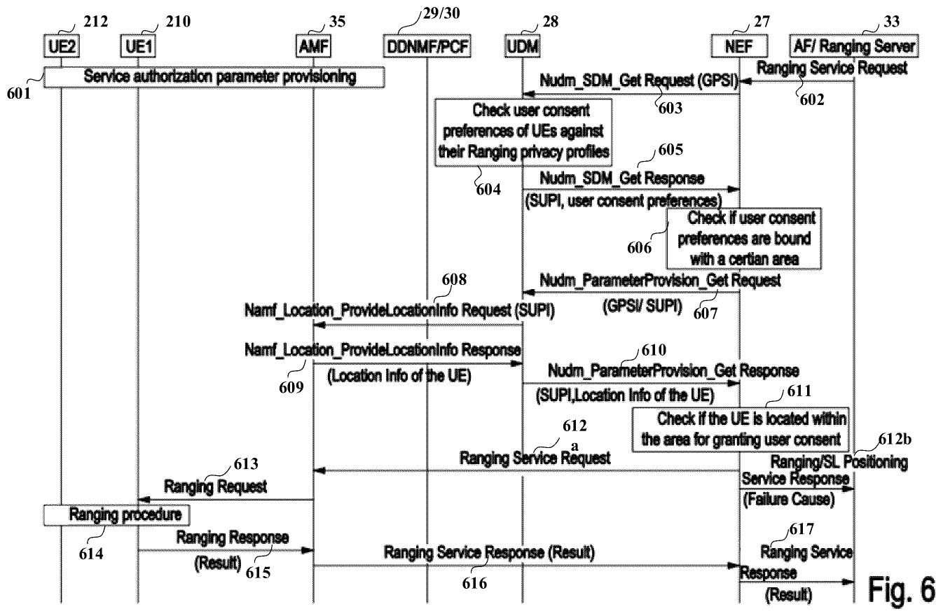

In FIG. 6, a further embodiment of the method according to the present disclosure is illustrated, the NEF is configured to communicate with the AMF by the UDM. The method steps implemented in the embodiment illustrated in FIG. 6 are as follows:

Step 601: Service authorization and policy/parameters provisioning procedure is performed between UE1/UE2 and the network system respectively.

Step 602: An AF/Ranging Server sends the Ranging service request to the NEF, including UE1 ID, UE2 ID, result content (distance, angle or both) and required QoS, etc.

Step 603: The NEF sends a message to the UDM (e.g. Nudm_SDM_Get Request) to discover the serving AMF of UE1/UE2 based on the UE1/UE2 ID (e.g. GPSI of UE1/UE2). The NEF may also check with the UDM whether the AF is authorized to acquire SL position of UE1 and UE2. Meanwhile, the NEF requests the user consent preferences of UE1 and UE2 from the UDM. It is noted that UE1 210 and UE2 212 (reference and target UEs), which can discover each other for SL positioning, for example should be in the vicinity of each other. Hence, for example the UEs are served by the same serving AMF.

Step 604: The UDM 28 checks the user consent preferences of UE1 and UE2 against the privacy profiles of the UEs based on the UE1 ID and UE2 ID.

Step 605: The UDM returns the user consent preferences of the UEs to the NEF.

Step 606: The NEF 27 checks the user consent preferences of both UEs. If none of the UEs grants or only one of the UEs does not grant user consent for SL positioning, the NEF aborts the network assisted SL positioning service (step 12b). In case both UEs grant user consent without location restriction, the NEF proceeds to step 12a. In case both UEs grant user consent, which is however restricted to a certain area, the NEF proceeds with step 7.

Step 607: The NEF sends a request message (e.g. Nudm_ParameterProvision_Get Request) to the UDM for requesting the rough location of UE1/UE2 (e.g. TAI or Cell-ID of UE1/UE2).

Step 608: The UDM sends a request message (e.g. Namf_Location_ProvideLocationInfo Request) to the AMF.

Step 609: The AMF 35 of UE1/UE2 sends a response message (e.g. Namf_Location_ProvideLocationInfo Response) to the UDM which contains the rough location of UE1/UE2 (e.g. TAI or Cell-ID of UE1/UE2).

Step 610: The UDM returns a message (e.g. Nudm_ParameterProvision_Get Response) to the NEF which contains the rough location of UE1/UE2 (e.g. TAI or Cell-ID of UE1/UE2).

Step 611: Based on the rough location of UE1/UE2, the NEF checks whether the UE1/UE2 is within the area for granting the user consent.

Step 612a: If both UEs grant user consent in their current locations, the NEF sends the SL positioning service request to the AMF of the UEs (e.g. UE1).

Step 612b: If none or one of the UEs does not grant user consent in its current location, the NEF responds to the AF/Ranging Server 33 with a failure cause.

Step 613: The AMF forwards the SL positioning service request to the UE1 over NAS. It is noted that UE1 can be either the target UE or the reference UE, depending on the request from the NEF.

Step 614: UE1 initiates ranging/SL positioning procedure to UE2 to trigger the measurement and the calculation of the result. The ranging/SL positioning procedure may include Sidelink positioning discovery and service operations.

Step 615: UE1 sends the ranging/SL positioning result to the AMF.

Step 616: The AMF forwards the SL positioning result to the NEF.

Step 617: The NEF forwards the Ranging result to the AF/Ranging Server.

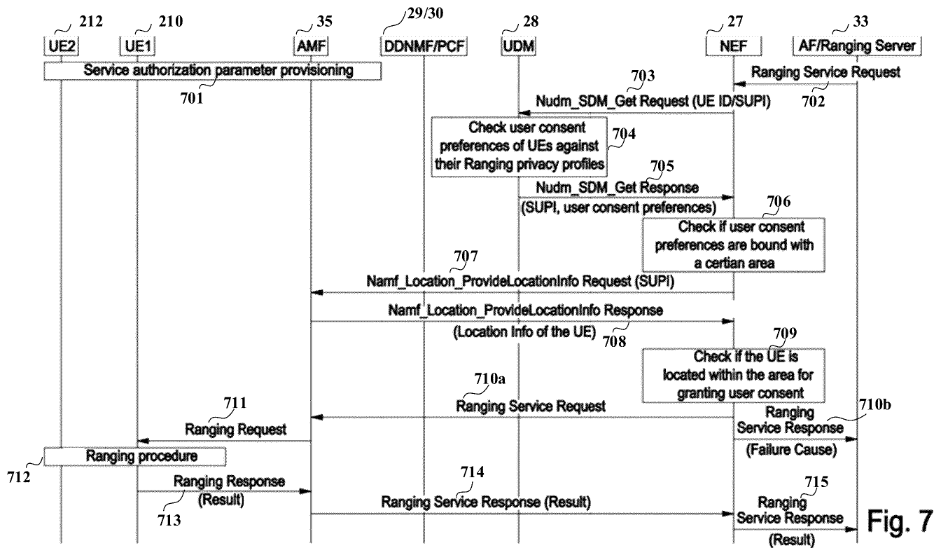

In FIG. 7, a further embodiment of the method according to the present disclosure is illustrated, the NEF is configured to communicate directly with the AMF (and not via the UDM according to the embodiment shown in FIG. 6). The direct communication between the NEF and the AMF is illustrated in steps 707 and 708 of FIG. 7. Apart from these steps, the further steps 701 to 706 and 709 to 715 depicted in FIG. 7 correspond to steps 601 to 606 and 611 to 617 shown in FIG. 6.

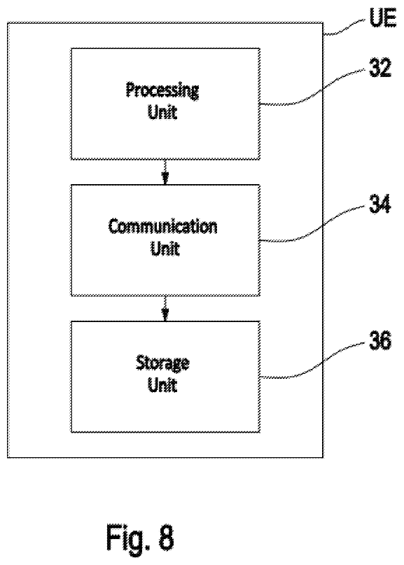

Finally, in FIG. 8, a user equipment (UE) according to the present disclosure is illustrated. The UE includes a processing unit 32, a communication unit 34 and a storage unit 36.

In order to solve the above-mentioned problem, according to one aspect of the present disclosure, a method is proposed for performing at least one of a sidelink positioning procedure or a ranging procedure in a communication system, in particular in a 5G communication system, wherein the communication system includes a network system, an application server (AS), a first User Equipment (UE1) and a second User Equipment (UE2), and where the network system includes a network exposure function (NEF), a unified data management function (UDM) and an access and mobility management function (AMF), the method comprising:
registering, by UE1 and UE2, with the network system;
receiving, by the NEF, a sidelink positioning request or a ranging service request from the AS;
sending, by the NEF, a data retrieval request to the UDM, wherein the data retrieval request prompts the UDM to provide privacy profile data of the UE1 and the UE2, and wherein the privacy profile data indicates whether a first user consent to share location information associated with the UE1 is present and whether a second user consent to share location information associated with the UE2 is present;
   receiving, by the NEF, the privacy profile data from the UDM;
   evaluating, by the NEF, the privacy profile data of the UE1 and UE2; and
   in case that the preceding evaluation has resulted in the presence of the first user consent to share location information associated with the UE1 and in the presence of the second user consent to share location information associated with the UE2:
performing at least one of the sidelink positioning procedure or the ranging procedure;
sending, by the NEF, a sidelink positioning result or a ranging service result to the AS.

The present invention allows to efficiently handle user privacy preferences without affecting the ranging/SL positioning procedure in a disadvantageous manner. Furthermore, the present invention allows to implement the additional measures to existing network architectures without causing any compatibility issues.

The communication system according to the present invention may be a 5G communication system or any other communication system based on the architecture of the 5G communication system. For instance, the method according to the present invention can also be applied to a communication system that is based on the 5G standard, but does not comprise all functions provided within the 5G standard. Further, the method can be applied to a communication system that includes further additional functions that are not encompassed by the 5G standard (for instance in a future communication standard comprising basically the same network architecture, in particular comprising the same functions as recited above and involved in the method according to the present invention). In some examples, the network system may be implemented as a 5G core network system.

The ranging/SL positioning procedure can be performed between a first and a second UE. However, the ranging/SL positioning procedure can also encompass additional UEs. Ranging procedures are in general known from the prior art. Ranging refers to the procedure of determining the distance between two or more UEs via a PC5interface. SL positioning refers to the procedure of positioning a UE using the PC5interface.

The network system according to the present invention may be a computer system comprising a processing unit, a memory unit, and a communication unit.

The application server (AS) can also be referred to as an application function (AF) or a ranging server (RS). The AS can be implemented as a computer system comprising a processing unit, a memory unit, and a communication unit.

The AMF is typically configured to interact with an access network and with UEs. The AMF may support establishing an encrypted signaling connection towards a UE, wherein the AMF may allow it to register, to be authenticated and to be moved between different radio cells of the network.

According to the present invention, the registration of UE1/UE2 with the network system may include the registration of UE1/UE2 with the AMF and the exchange of authorization data, setting parameters, etc. between each of the UEs and the AMF.

Sending, by the NEF, a data retrieval request to the UDM may comprise sending a UE1 ID and a UE2 ID for identifying each of the UEs.

The privacy profile data may comprise different types of information. For instance, the privacy profile data may comprise a first binary flag indicating whether a user consent is granted for UE1 and a second binary flag indicating whether a user consent is granted for UE2. Furthermore, in order to enable the handling of more specific privacy preferences, the privacy profile data may comprise area-specific consent data or time-specific consent data. Hence, the privacy profile data may indicate an absolute grant of consent for sharing location information or a consent for sharing location information that depends on predetermined conditions. In some examples, the privacy profile data for at least one of the UEs may be bound to a SUPI or a GPSI of the corresponding UE. In some examples, evaluating the privacy profile data of the UE1 and UE2 comprises the following steps:
determining, by the NEF, whether the privacy profile data comprises area-specific consent data for at least one of the UE1 or the UE2; and
in case it is determined that the privacy profile data comprises area-specific consent data for at least one of the UE1 or the UE2:
obtaining, by the NEF, position estimation data for at least one of the UE1 or the UE2 being associated with the area-specific consent data; and
determining, by the NEF, whether the area-specific consent data matches the obtained position estimation data for at least one of the UE1 or the UE2 being associated with the area-specific consent data.

The area-specific consent data can also be referred to as area-depending consent data. For instance, the area-specific consent data may indicate that a user consent is granted for a specific area, e.g. for a specific country, province, city, district or street. The indicated area may be encoded in location data in text format or by way of GPS location data. For instance, the area-specific consent data may comprise different fields indicating the country and the city for which the user consent is granted. As an alternative, the area-specific consent data may comprise a GPS location defining a specific position and additional distance data indicating at which distance from the encoded GPS position the user consent is granted. The area-specific consent data may define a coherent area or, alternatively, separate areas that are not connected with each other. For instance, the area-specific consent data may define two cities of different provinces or two streets in different cities for which the user's consent to share location information is granted.

In some examples, obtaining position estimation data for at least one of the UE1 or the UE2 being associated with the area-specific consent data comprises the following steps:
sending, by the NEF, a request message for obtaining the position estimation data for at least one of the UE1 or the UE2 being associated with the area-specific consent data, to the AMF;
receiving, by the NEF, the requested position estimation data for at least one of the UE1 or the UE2 being associated with the area-specific consent data from the AMF.

In some examples, sending a request message for obtaining the position estimation data for at least one of the UE1 or the UE2 being associated with the area-specific consent data comprises the following steps:
sending, by the NEF, the request message for obtaining the position estimation data for at least one of the UE1 or the UE2 being associated with the area-specific consent data to the UDM; and
sending, by the UDM, the request message for obtaining the position estimation data for at least one of the UE1 or the UE2 being associated with the area-specific consent data to the AMF;
and/or
receiving the requested position estimation data for at least one of the UE1 or the UE2 being associated with the area-specific consent data from the AMF comprises the following steps:
receiving, by the UDM, the requested position estimation data for at least one of the UE1 or the UE2 being associated with the area-specific consent data from the AMF; and
receiving, by the NEF, the requested position estimation data for at least one of the UE1 or the UE2 being associated with the area-specific consent data from the UDM.

In some examples, evaluating the privacy profile data of the UE1 and the UE2 comprises the following steps:
determining, by the NEF, whether the privacy profile data comprises time-specific consent data for at least one of the UE1 or the UE2; and
in case it is determined that the privacy profile data comprises time-specific consent data for at least one of the UE1 or the UE2:
determining, by the NEF, whether requirements of the time-specific consent data are satisfied.

The time-specific consent data may also be referred to as time-depending consent data. For instance, the time specific consent data may comprise predetermined fields indicating specific days of the week and/or specific hours for which a user consent to share location information is granted. According to one illustrative example, the time-specific consent data may indicate that a user consent is granted Mondays to Fridays from 8 AM to 5 PM. Outside the defined time, a user might not consent to sharing his location information. Alternatively, the time-specific consent data may indicate a specific time for which the user consent is not granted. For instance, the time-specific consent data may indicate that sharing location information shall not be shared from Friday 5 PM to Monday 8 AM. In a similar manner, the time-specific consent data may indicate that location information may be shared on specific days of each month or may not be shared during a specific period of the year.

In some examples, performing at least one of the sidelink positioning procedure or the ranging procedure in case the preceding evaluation has resulted in the presence of the first user consent to share location information associated with the UE1 and in the presence of the second user consent to share location information associated with the UE2 comprises the following steps:
sending, by the NEF, at least one of a sidelink positioning procedure request or a ranging procedure request to the UE1;
initiating, by the UE1, at least one of the requested sidelink positioning procedure or the requested ranging procedure with UE2;
providing, by the UE1, at least one of a sidelink positioning procedure result or the ranging procedure result to the NEF.

In some examples, sending at least one of a sidelink positioning procedure request or a ranging procedure request to the UE1 comprises the following steps:
ending, by the NEF, at least one of a sidelink positioning procedure request or a ranging procedure request to the AMF; and
sending, by the AMF, at least one of a sidelink positioning procedure request or a ranging procedure request to the UE1;
and
providing at least one of a sidelink positioning procedure result or the ranging procedure result to the NEF comprises the following steps:
providing, by the UE1, at least one of a sidelink positioning procedure result or the ranging procedure result to the AMF; and
providing, by the AMF, at least one of a sidelink positioning procedure result or the ranging procedure result to the NEF.

According to a further aspect of the present invention, a method is proposed providing, by a unified data management (UDM), assistance information to a network exposure function (NEF), for performing at least one of a sidelink positioning procedure or a ranging procedure in a communication system, in particular in a 5G communication system, wherein the communication system comprises a network system, an application server (AS) a first User Equipment (UE1) and a second User Equipment (UE2), and wherein the network system comprises the network exposure function (NEF), the unified data management function (UDM) and an access and mobility management function (AMF), the method comprising the following steps:
receiving, by the UDM, a data retrieval request from the NEF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieving, by the UDM, the privacy profile data of the UE1 and the UE2 from a database within the UDM, in particular from a unified data repository (UDR) of the UDM; and
sending, by the UDM, the retrieved privacy profile data of the UE1 and the UE2 to the NEF.

The UDM may be implemented as a front-end for user subscription data stored in a database. The database may also be referred to as a unified data repository (UDR). Typically, when a UE attaches to the network system, the UDM authorizes the access and performs several checks of supported features. Among others, subscription data is stored in the UDM, wherein the subscription data typically defines various types of network or user policies. The data stored within the UDM is offered as services to other network functions (NFs), in particular to the NEF.

In some examples, the UDM is configured to receive privacy profile data of the UE1 and the UE2 to update its database with regard to current privacy settings of the UE1 and UE2.

In some examples, the privacy profile data comprises area-specific consent data for at least one of the UE1 or the UE2.

In some examples, the method may comprise the following steps:
receiving, by the UDM, a request message for obtaining position estimation data for at least one of the UE1 or the UE2 being associated with the area-specific consent data from the NEF;
sending, by the UDM, a request message for obtaining the position estimation data for at least one of the UE1 or the UE2 being associated with the area-specific consent data to the AMF;
receiving, by the UDM, the requested position estimation data for at least one of the UE1 or the UE2 being associated with the area-specific consent data from the AMF; and
sending, by the UDM, the requested position estimation data for at least one of the UE1 or the UE2 being associated with the area-specific consent data to the NEF.

In some examples, the privacy profile data comprises time-specific consent data for at least one of the UE1 or the UE2.

According to a further aspect of the present invention, a method is proposed for providing, by an Access and Mobility Management Function (AMF), position estimation data for a first User Equipment (UE1) and a second User Equipment (UE2) for performing at least one of a sidelink positioning procedure or a ranging procedure in a communication system, in particular in a 5G communication system, wherein the communication system comprises a network system, an application Server (AS), the first User Equipment (UE1) and the second User Equipment (UE2), and wherein the network system comprises a network exposure function (NEF), a unified data management function (UDM) and the access and mobility management function (AMF), the method comprising the following steps:
receiving, by the AMF, a request message for obtaining the position estimation data for at least one of the UE1 or the UE2 being associated with an area-specific consent data from the NEF or from the UDM;
sending, by the AMF, the requested position estimation data for at least one of the UE1 or the UE2 associated with the area-specific consent data to the requesting NEF or the requesting UDM.

In some examples, the position estimation data comprises a Tracking Areas Identity (TAI) or a cell ID, in particular a NR Cell Global Identifier (NCGI).

According to a further aspect of the present invention, a network system is proposed that can be implemented in a communication system, in particular to be implemented in a 5G communication system, wherein the network system comprises a network exposure function (NEF), a unified data management function (UDM) and an access and mobility management function (AMF), wherein the NEF is configured to:
receive a sidelink positioning request or a ranging service request from an application server (AS);
send a data retrieval request to the UDM, wherein the data retrieval request prompts the UDM to provide privacy profile data of a first User Equipment (UE1) and a second user equipment (UE2), and wherein the privacy profile data indicates whether a first user consent to share location information associated with the UE1 is present and whether a second user consent to share location information associated with the UE2 is present;
receive the privacy profile data from the UDM;
evaluate the privacy profile data of the UE1 and UE2;
in case the preceding evaluation has resulted in the presence of the first user consent to share location information associated with the UE1 and in the presence of the second user consent to share location information associated with the UE2:
initiate at least one of a sidelink positioning procedure or a ranging procedure
send at least one of a sidelink positioning result or a ranging service result to the AS.

The network system may comprise a computing unit, a communication module and a storage medium. The network system may be implemented as a 5G core network system that can be applied in a 5G communication system.

In some examples the NEF is further configured to:
determine whether the privacy profile data comprises area-specific consent data for at least one of the UE1 or the UE2; and
in case it is determined that the privacy profile data comprises area-specific consent data for at least one of the UE1 or the UE2:
obtain position estimation data for at least one of the UE1 or the UE2 being associated with the area-specific consent data; and
determine whether the area-specific consent data matches the obtained position estimation data for at least one of the UE1 or the UE2 being associated with the area-specific consent data.

In some examples, the NEF is further configured to:
send a request message for obtaining the position estimation data for at least one of the UE1 or the UE2 being associated with the area-specific consent data, to the AMF;
receive the requested position estimation data for at least one of the UE1 or the UE2 being associated with the area-specific consent data from the AMF.

In some examples, the NEF is further configured to:
send the request message for obtaining the position estimation data for at least one of the UE1 or the UE2 being associated with the area-specific consent data to the UDM; and
receive the requested position estimation data for at least one of the UE1 or the UE2 being associated with the area-specific consent data from the UDM.

In some examples, the NEF is further configured to:
determine whether the privacy profile data comprises time-specific consent data for at least one of the UE1 or the UE2; and
in case it is determined that the privacy profile data comprises time-specific consent data for at least one of the UE1 or the UE2:
determine whether requirements of the time-specific consent data are satisfied.

In some examples, the NEF is further configured to:
send at least one of a sidelink positioning procedure request or a ranging procedure request to the UE1;
receive at least one of a sidelink positioning procedure result or the ranging procedure result from the UE1.

In some examples, the NEF is further configured to:
send at least one of a sidelink positioning procedure request or a ranging procedure request to the AMF; and
receive at least one of a sidelink positioning procedure result or the ranging procedure result from the AMF.

According to a further aspect of the present invention, a network system is proposed that can be implemented in a 5G communication system, wherein the network system comprises a network exposure function (NEF), a unified data management function (UDM) and an access and mobility management function (AMF), wherein the UDM is configured to:
receive a data retrieval request from the NEF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieve the privacy profile data of the UE1 and the UE2 from a database within the UDM, in particular from a unified data repository (UDR) of the UDM; and
sending the retrieved privacy profile data of the UE1 and the UE2 to the NEF.

In some examples, the UDM is further configured to receive privacy profile data of the UE1 and the UE2 to update its database with regard to current privacy settings of the UE1 and UE2.

In some examples, the privacy profile data comprises area-specific consent data for at least one of the UE1 or the UE2.

In some examples, the UDM is further configured to:
receive a request message for obtaining position estimation data for at least one of the UE1 or the UE2 being associated with the area-specific consent data from the NEF;
send a request message for obtaining the position estimation data for at least one of the UE1 or the UE2 being associated with the area-specific consent data to the AMF;
receive the requested position estimation data for at least one of the UE1 or the UE2 being associated with the area-specific consent data from the AMF; and
send the requested position estimation data for at least one of the UE1 or the UE2 being associated with the area-specific consent data to the NEF.

In some examples, the privacy profile data comprises time-specific consent data for at least one of the UE1 or the UE2.

According to a further aspect of the present invention, a network system is proposed that can be implemented in a communication system, in particular to be implemented in a 5G communication system, wherein the network system comprises a network exposure function (NEF), a unified data management function (UDM) and an access and mobility management function (AMF), wherein the AMF is configured to:
receive a request message for obtaining the position estimation data for at least one of the UE1 or the UE2 being associated with an area-specific consent data from the NEF or from the UDM;
send the requested position estimation data for at least one of the UE1 or the UE2 associated with the area-specific consent data to the requesting NEF or the requesting UDM.

In some examples, the position estimation data comprises a Tracking Areas Identity (TAI) or a cell ID, in particular a NR Cell Global Identifier (NCGI).

According to a further aspect of the present invention, a user equipment (UE) is proposed that can be used in a communication system, in particular in a 5G communication system, wherein the UE comprises a processing unit, a communication unit and a storage unit, wherein the storage unit has privacy profile data stored thereon, wherein the privacy profile data indicates whether a user consent to share location information associated with the UE1 is present.

In some examples, the privacy profile data comprises area-specific consent data.

In some examples, the privacy profile data comprises time-specific consent data.

According to a further aspect of the present invention, a computer program product is proposed that, when executed by a processing unit, causes the processing unit to perform the method according to any one of the above-described methods.

1. A method for performing at least one of a sidelink positioning procedure or a ranging procedure in a communication system, wherein the communication system comprises a network system, an application server (AS), a first User Equipment (UE1) and a second User Equipment (UE2), and wherein the network system comprises a network exposure function (NEF), a unified data management function (UDM) and an access and mobility management function (AMF), the method comprising:
registering, by UE1 and UE2, with the network system;
receiving, by the NEF, a sidelink positioning request or a ranging service request from the AS;
sending, by the NEF, a data retrieval request to the UDM, wherein the data retrieval request prompts the UDM to provide privacy profile data of the UE1 and the UE2, and wherein the privacy profile data indicates whether a first user consent to share location information associated with the UE1 is present and whether a second user consent to share location information associated with the UE2 is present;
receiving, by the NEF, the privacy profile data from the UDM;
evaluating, by the NEF, the privacy profile data of the UE1 and UE2; and
determining that the preceding evaluation has resulted in the presence of the first user consent to share location information associated with the UE1 and in the presence of the second user consent to share location information associated with the UE2; and
performing at least one of the sidelink positioning procedure or the ranging procedure; and
sending, by the NEF, at least one of a sidelink positioning result or a ranging service result to the AS.

2. The method according to claim 1, wherein evaluating, by the NEF, the privacy profile data of the UE1 and UE2 comprises:
determining, by the NEF, whether the privacy profile data comprises area-specific consent data for at least one of the UE1 or the UE2; and
determining that the privacy profile data comprises area-specific consent data for at least one of the UE1 or the UE2; and
obtaining, by the NEF, position estimation data for at least one of the UE1 or the UE2 being associated with the area-specific consent data; and
determining, by the NEF, whether the area-specific consent data matches the obtained position estimation data for at least one of the UE1 or the UE2 being associated with the area-specific consent data.

3. The method according to claim 2, wherein obtaining, by the NEF, position estimation data for at least one of the UE1 or the UE2 being associated with the area-specific consent data comprises:
sending, by the NEF, a request message for obtaining the position estimation data for at least one of the UE1 or the UE2 being associated with the area-specific consent data, to the AMF;
receiving, by the NEF, the requested position estimation data for at least one of the UE1 or the UE2 being associated with the area-specific consent data from the AMF.

4. The method according to claim 3, wherein sending a request message for obtaining the position estimation data for at least one of the UE1 or the UE2 being associated with the area-specific consent data comprises:
sending, by the NEF, the request message for obtaining the position estimation data for at least one of the UE1 or the UE2 being associated with the area-specific consent data to the UDM; and
sending, by the UDM, the request message for obtaining the position estimation data for at least one of the UE1 or the UE2 being associated with the area-specific consent data to the AMF;
and/or
receiving the requested position estimation data for at least one of the UE1 or the UE2 being associated with the area-specific consent data from the AMF comprises:
receiving, by the UDM, the requested position estimation data for at least one of the UE1 or the UE2 being associated with the area-specific consent data from the AMF; and
receiving, by the NEF, the requested position estimation data for at least one of the UE1 or the UE2 being associated with the area-specific consent data from the UDM.

5. The method according to claim 1, wherein evaluating, by the NEF, the privacy profile data of the UE1 and the UE2 comprises:
determining, by the NEF, whether the privacy profile data comprises time-specific consent data for at least one of the UE1 or the UE2; and
determining that that the privacy profile data comprises time-specific consent data for at least one of the UE1 or the UE2 and determining, by the NEF, whether requirements of the time-specific consent data are satisfied.

6. The method according to claim 1, wherein performing at least one of the sidelink positioning procedure or the ranging procedure in case that the preceding evaluation has resulted in the presence of the first user consent to share location information associated with the UE1 and in the presence of the second user consent to share location information associated with the UE2 comprises:
sending, by the NEF, at least one of a sidelink positioning procedure request or a ranging procedure request to the UE1;
initiating, by the UE1, at least one of the requested sidelink positioning procedure or the requested ranging procedure with UE2;
providing, by the UE1, at least one of a sidelink positioning procedure result or the ranging procedure result to the NEF.

7. The method according to claim 6, wherein sending, by the NEF, at least one of a sidelink positioning procedure request or a ranging procedure request to the UE1 comprises:
sending, by the NEF, at least one of a sidelink positioning procedure request or a ranging procedure request to the AMF; and
sending, by the AMF, at least one of a sidelink positioning procedure request or a ranging procedure request to the UE1;
and
providing at least one of a sidelink positioning procedure result or the ranging procedure result to the NEF comprises:
providing, the UE1, at least one of a sidelink positioning procedure result or the ranging procedure result to the AMF; and
providing, by the AMF, at least one of a sidelink positioning procedure result or the ranging procedure result to the NEF.

8. A method for providing, by a unified data management (UDM), assistance information to a network exposure function (NEF), for performing at least one of a sidelink positioning procedure and/or a ranging procedure in a communication system, wherein the communication system comprises a network system, an application server (AS) a first User Equipment (UE1) and a second User Equipment (UE2), and wherein the network system comprises the network exposure function (NEF), the unified data management function (UDM) and an access and mobility management function (AMF), the method comprising:
receiving, by the UDM, a data retrieval request from the NEF, wherein the data retrieval request prompts the UDM to provide privacy profile data of the UE1 and the UE2, and wherein the privacy profile data indicates whether a first user consent to share location information associated with the UE1 is present, and whether a second user consent to share location information associated with the UE2 is present;
retrieving, by the UDM, the privacy profile data of the UE1 and the UE2 from a database within the UDM; and
sending, by the UDM, the retrieved privacy profile data of the UE1 and the UE2 to the NEF.

9. The method according to claim 8, wherein the UDM is configured to receive privacy profile data of the UE1 and the UE2 to update its database with regard to current privacy settings of the UE1 and UE2.

10. The method according to claim 8, wherein the privacy profile data comprises area-specific consent data for at least one of the UE1 or the UE2.

11. The method according to claim 10, further comprising:
receiving, by the UDM, a request message for obtaining position estimation data for at least one of the UE1 or the UE2 being associated with the area-specific consent data from the NEF;
sending, by the UDM, a request message for obtaining the position estimation data for at least one of the UE1 or the UE2 being associated with the area-specific consent data to the AMF;
receiving, by the UDM, the requested position estimation data for at least one of the UE1 or the UE2 being associated with the area-specific consent data from the AMF; and
sending, by the UDM, the requested position estimation data for at least one of the UE1 or the UE2 being associated with the area-specific consent data to the NEF.

12. The method according to claim 8, wherein the privacy profile data comprises time-specific consent data for at least one of the UE1 or the UE2.

13. A Method for providing, by an Access and Mobility Management Function (AMF), position estimation data for a first User Equipment (UE1) and a second User Equipment (UE2) for performing at least one of a sidelink positioning procedure or a ranging procedure in a communication system, wherein the communication system comprises a network system, an application Server (AS), the first User Equipment (UE1) and the second User Equipment (UE2), and wherein the network system comprises a network exposure function (NEF), a unified data management function (UDM) and the access and mobility management function (AMF), the method comprising:
receiving, by the AMF, a request message for obtaining the position estimation data for at least one of the UE1 or the UE2 being associated with an area-specific consent data from the NEF or from the UDM;
sending, by the AMF, the requested position estimation data for at least one of the UE1 or the UE2 associated with the area-specific consent data to the requesting NEF or the requesting UDM.

14. The method according to claim 13, wherein the position estimation data comprises a Tracking Areas Identity (TAI) or a cell ID.

15. A network system to be implemented in a communication system, wherein the network system comprises a network exposure function (NEF), a unified data management function (UDM) and an access and mobility management function (AMF), wherein the NEF is configured to: carry out steps performed by the NEF in the method according to claim 1.

16.-21. (canceled)

22. A network system to be implemented in a communication system, wherein the network system comprises a network exposure function (NEF), a unified data management function (UDM) and an access and mobility management function (AMF), wherein the UDM is configured to carry out the method according to claim 8.

23.-26. (canceled)

27. A network system to be implemented in a communication system, wherein the network system comprises a network exposure function (NEF), a unified data management function (UDM) and an access and mobility management function (AMF), wherein the AMF is configured to: carry out the method according to claim 13.

28. (canceled)

29. A user equipment (UE) to be used in a communication system, wherein the UE comprises a processing unit, a communication unit and a storage unit, wherein the storage unit has privacy profile data-stored thereon, wherein the privacy profile data indicates whether a user consent to share location information associated with the UE1 is present., the UE is configured to carry out steps performed by the UE1 in the method according to claim 1.

30. The UE according to claim 29, wherein the privacy profile data comprises at least one of area-specific consent data or time-specific consent data.

31. (canceled)

32. A computer program product that, in response to determining that executed by a processing unit, causes the processing unit to carry out the method according to claim 1.
